(19) United States
(12) Patent Application Publication
(10) Pub. No.: US 2014/0103778 A1
(43) Pub. Date: Apr. 17, 2014

(54) VIBRATOR, MANUFACTURING METHOD OF VIBRATOR, ELECTRONIC APPARATUS, AND MOBILE UNIT

(71) Applicant: Seiko Epson Corporation, Tokyo (JP)

(72) Inventors: Shogo INABA, Shiojiri (JP); Masahiro FUJII, Shiojiri (JP)

(73) Assignee: Seiko Epson Corporation, Tokyo (JP)

(21) Appl. No.: 14/047,302

(22) Filed: Oct. 7, 2013

(30) Foreign Application Priority Data
Oct. 12, 2012 (JP) 2012-226670
Nov. 16, 2012 (JP) 2012-252006

(51) Int. Cl. H02N 1/00

(52) U.S. Cl. CPC H02N 1/006
USPC 310/300; 29/829

(57) ABSTRACT

A MEMS vibrator includes a wafer substrate, a fixed lower electrode (first electrode) disposed on a principal surface of the wafer substrate, a support member whose one end is fixed to the wafer substrate, and a movable upper electrode (second electrode) joined to the other end of the support member and having a region overlapping the fixed lower electrode with a gap. The support member has a reinforcing region where the thickness of the support member in a thickness direction of the wafer substrate is larger than the thickness of the movable upper electrode in the thickness direction of the wafer substrate.

### BACKGROUND

1. Technical Field

The present invention relates to a vibrator, a manufacturing method of a vibrator, an electronic apparatus, and a mobile unit.

2. Related Art

In general, electromechanical system structures (for example, a vibrator, a filter, a sensor, a motor, and the like) including a mechanically movable structure that is formed using a micro processing technique and called a MEMS (micro electromechanical system) device have been known. Among them, a MEMS vibrator is easily manufactured incorporating a semiconductor circuit and thus advantageous for miniaturization and higher functionality, compared to a vibrator and a resonator that are formed using quartz crystal or a dielectric, which have been mainly used so far. Therefore, the MEMS vibrator has been actively utilized.

As representative examples of MEMS vibrators in the related art, a comb-type vibrator that vibrates in a direction parallel to a substrate surface and a beam-type vibrator that vibrates in a thickness direction of a substrate have been known. The beam-type vibrator is a vibrator including a lower electrode (fixed electrode) formed on a substrate and an upper electrode (movable electrode) arranged above the lower electrode with a gap. Depending on how to support the upper electrode, a clamped-free beam vibrator, a clamped-clamped beam vibrator, a free-free beam vibrator, and the like have been known.

In the free-free beam MEMS vibrator, the portion of a node of vibration of an upper electrode that vibrates is supported by a support member. Therefore, the free-free beam MEMS vibrator has reduced vibration leakage to the substrate and high vibration efficiency. U.S. Pat. No. 6,930,569 B2 proposes a technique for improving vibration characteristics by properly setting the length of the support member with respect to the frequency of vibration.

However, the above-described related art including the MEMS vibrator disclosed in U.S. Pat. No. 6,930,569 B2 has a problem of failing to meet needs of downsizing, thinning, power saving, higher frequency, and the like. Specifically, for responding to the needs of downsizing, thinning, power saving, higher frequency, and the like, it is effective to use the free-free beam MEMS vibrator to reduce the stiffness of the upper electrode or support portion or to reduce the gap between the electrodes. As a result, however, sticking of the upper electrode in a manufacturing step is induced, leading to a problem of failing to obtain sufficient manufacturing yield. The sticking is a phenomenon that when a sacrificial layer is removed by etching for forming a MEMS structure, a micro structure is adhered to a substrate or another structure. That is, in the related art, the problem of the sticking of the upper electrode to the lower electrode in a manufacturing step has become obvious together with responding to the needs described above.

### SUMMARY

An advantage of some aspects of the invention is to solve at least a part of the problems described above, and the invention can be implemented as the following modes or application examples.

### Application Example 1

This application example is directed to a vibrator including: a substrate; a first electrode disposed on a principal surface of the substrate; a support member fixed to the substrate; and a second electrode joined to the support member, being spaced apart from the first electrode, and having a region overlapping the first electrode in plan view of the substrate, wherein the support member has a reinforcing region where the thickness of the support member in a thickness direction of the substrate is larger than the thickness of the second electrode in the thickness direction of the substrate.

According to this application example, the support member that supports the second electrode having the region overlapping the first electrode with a gap has the reinforcing region where the thickness of the support member is larger than the thickness of the second electrode in the thickness direction of the substrate. With the reinforcing region, the rigidity of the support member in the thickness direction of the substrate is increased. As a result, even when an external force acts in a direction in which the second electrode approaches the first electrode, the second electrode is less likely to approach the first electrode. Accordingly, in the case where, for example, a sacrificial layer is removed by etching for forming the second electrode and the first electrode, even when the surface tension or the like of an etching solution or cleaning liquid acts between the second electrode and the first electrode, a sticking phenomenon that the second electrode is adhered to the first electrode is less likely to occur. As a result, a reduction in yield due to the sticking can be suppressed.

### Application Example 2

This application example is directed to the vibrator according to the application example described above, wherein the second electrode is a vibrating plate that flexurally vibrates in the thickness direction of the substrate, and a node portion of the flexural vibration of the second electrode is joined to the other end of the support member.

According to this application example, the second electrode is a vibrating plate that flexurally vibrates in the thickness direction of the substrate, and the node portion of the flexural vibration of the second electrode is joined to the other end of the support member. Moreover, the rigidity of the support member is enhanced in the thickness direction of the substrate with the reinforcing region. Accordingly, even when the rigidity of the support member is increased to increase the stiffness, vibration is not significantly prevented because the support member supports the node portion of the vibration of the second electrode. That is, the support member more effectively supports the second electrode without adversely affecting vibration characteristics, which makes it possible to suppress the sticking phenomenon.

### Application Example 3

This application example is directed to the vibrator according to the application example described above, wherein the vibrator includes a plurality of pairs of the support members each pair of which interpose the second electrode therebetween.

According to this application example, both ends of the node portion of the vibration of the second electrode are supported by the pair of support members, and the second electrode is supported at a plurality of points by the pair of support members. The second electrode is supported by a plurality of support members, which makes it possible to more effectively suppress the sticking phenomenon. Moreover, since the second electrode is supported at the node portion of vibration, the vibration characteristics are not deteriorated.

### Application Example 4

This application example is directed to the vibrator according to the application example described above, wherein the reinforcing region is a region where the thickness of the support member in the thickness direction of the substrate is larger in a direction away from the principal surface of the substrate than the thickness of the second electrode in the thickness direction of the substrate.

As in this application example, the reinforcing region is composed of a region where the thickness is large in the direction away from the principal surface of the substrate with respect to the support member, which makes it possible to enhance the rigidity of the support member without changing the size (distance) of the gap between the second electrode and the first electrode. That is, the sticking phenomenon can be suppressed without deteriorating characteristics as a vibrator.

### Application Example 5

This application example is directed to the vibrator according to the application example described above, wherein the thickness of the reinforcing region in the thickness direction of the substrate increases with distance from the other end of the support member.

According to this application example, the thickness of the reinforcing region in the thickness direction of the substrate increases with distance from the other end of the support member. With this configuration, since the concentration of stress from the support member on the joint portion between the support member and the second electrode is suppressed, it is possible to suppress the occurrence of a crack at the joint portion caused by vibration or impact.

### Application Example 6

This application example is directed to a manufacturing method of a vibrator including a substrate, a first electrode disposed on a principal surface of the substrate, a support member fixed to the substrate, and a second electrode joined to the support member, being spaced apart from the first electrode, and having a region overlapping the first electrode in plan view of the substrate, wherein the support member has a reinforcing region where the thickness of the support member in a thickness direction of the substrate is larger than the thickness of the second electrode in the thickness direction of the substrate, the method including: stacking a first conductive layer forming the support member, or the support member and the second electrode; removing at least a portion of the first conductive layer while leaving a region for forming the support member; and stacking a second conductive layer forming the support member and the second electrode.

According to this application example, by selectively stacking the first conductive layer and the second conductive layer in the region for forming the support member, the reinforcing region can be formed in the support member. As a result, the vibrator according to the application example can be simply manufactured.

### Application Example 7

This application example is directed to a manufacturing method of a vibrator including a substrate, a first electrode disposed on a principal surface of the substrate, a support member fixed to the substrate, and a second electrode joined to the support member, being spaced apart from the first electrode, and having a region overlapping the first electrode in plan view of the substrate, wherein the support member has a reinforcing region where the thickness of the support member in a thickness direction of the substrate is larger than the thickness of the second electrode in the thickness direction of the substrate, the method including: stacking a conductive layer forming the support member and the second electrode; and removing a portion of the conductive layer while leaving a region for forming the support member.

According to this application example, the conductive layer stacked in the region for forming the support member is left without being selectively removed, which makes it possible to form the reinforcing region in the support member. As a result, the vibrator according to the application example can be simply manufactured.

### Application Example 8

This application example is directed to a vibrator including: a vibrating portion; and a support member extended from the vibrating portion, wherein the support member has a portion of a different thickness in a cross-section as viewed from a direction in which the support member is extended.

According to this vibrator, the support member has the portion of a different thickness in the cross-section as viewed from the direction in which the support member is extended. With the portion of a different thickness, the displacement of the support member in a rotational axis direction caused by the vibration of the vibrating portion, that is, the twisting of the support member can be allowed. Therefore, the support member can maintain its rigidity by reducing the thickness of a portion of the support member, and the portion of a different thickness can twist with the vibration of the vibrating portion irrespective of the length of the support member. Accordingly, since the portion of a different thickness of the support member is twisted, it is possible to improve vibration characteristics and suppress the sticking of the vibrating portion caused by the flex of the support member.

### Application Example 9

This application example is directed to the vibrator according to the application example described above, wherein a plurality of the support members are extended from the vibrating portion.

According to this vibrator, a plurality of support members are extended from the vibrating portion. Since the plurality of support members are extended, the vibrating portion can be stably supported. Accordingly, the sticking of the vibrating portion can be effectively suppressed.

### Application Example 10

This application example is directed to the vibrator according to the application example described above, wherein the support member is extended from a portion serving as a node of vibration of the vibrating portion.

According to this vibrator, the support member is extended from the portion serving as the node of vibration of the vibrating portion. Since the support member is extended from the node of vibration and thus the vibrating portion is supported at the node of vibration, restriction on the vibration of the vibrating portion can be suppressed. That is to say, the deterioration of vibration characteristics of the vibrating portion can be suppressed. Accordingly, sticking of the vibrating portion can be suppressed without restricting the vibration of the vibrating portion.

### Application Example 11

This application example is directed to the vibrator according to the application example described above, wherein a fixing portion that fixes the support member on a substrate is disposed.

According to this vibrator, the fixing portion that fixes the support member on the substrate is disposed. Since the fixing portion is disposed and thus the support member is fixed to the substrate, the vibrating portion can be stably supported. Accordingly, the sticking of the vibrating portion can be effectively suppressed.

### Application Example 12

This application example is directed to a manufacturing method of a vibrator including a vibrating portion and a support member extended from the vibrating portion, wherein the support member has a portion of a different thickness in a cross-section as viewed from a direction in which the support member is extended, the method including: forming the vibrating portion and the support member; forming a fixing portion and a lower electrode; forming an intermediate layer on the support member at the portion of a different thickness; and removing the intermediate layer after forming the support member.

According to this manufacturing method, the forming of the intermediate layer at the portion of the support member where the thickness is made different and the removing of the intermediate layer after forming the support member are included. By disposing the intermediate layer at the portion of a different thickness in the forming of the support member, the support member is formed so as not to be formed at the portion of a different thickness, and thereafter, by removing the intermediate layer, the portion of a different thickness can be formed in the support member. Accordingly, it is possible to manufacture the vibrator that can improve vibration characteristics and suppress sticking of the vibrating portion caused by the flex of the support member because the portion of a different thickness of the support member is twisted.

### Application Example 13

This application example is directed to an electronic apparatus including the vibrator according to the application example described above.

According to this electronic apparatus, the vibrator in which the occurrence of sticking is suppressed is mounted, which makes it possible to obtain an electronic apparatus with high reliability.

### Application Example 14

This application example is directed to a mobile unit including the vibrator according to the application example described above or the electronic apparatus according to the application example described above.

According to this mobile unit, the vibrator in which the occurrence of sticking is suppressed is mounted, or the electronic apparatus, on which the vibrator in which the occurrence of sticking is suppressed is mounted, is mounted, which makes it possible to obtain a mobile unit with high reliability.

### BRIEF DESCRIPTION OF THE DRAWINGS

The invention will be described with reference to the accompanying drawings, wherein like numbers reference like elements.

FIG. 1A is a sectional side elevation showing a MEMS vibrator as a vibrator according to a first embodiment; FIG. 1B is a perspective view of the MEMS vibrator; and FIG. 1C is a cross-sectional view showing how a movable upper electrode (second electrode) vibrates.

FIGS. 2A and 2B are sectional side elevations showing a related-art MEMS vibrator.

FIGS. 3A to 3F are step diagrams showing in order a manufacturing method of a MEMS vibrator.

FIG. 4 is a perspective view showing a schematic configuration of a vibrator according to a second embodiment.

FIG. 5 is a cross-sectional view showing a schematic configuration of the vibrator according to the second embodiment.

FIG. 6 is a cross-sectional view showing a schematic configuration and an operating state of the vibrator according to the second embodiment.

FIG. 7 is a perspective view showing a support member of the vibrator according to the second embodiment.

FIGS. 8A1 to 8C2 are cross-sectional views showing manufacturing steps of the vibrator according to the second embodiment.

FIGS. 9D1 to 9E2 are cross-sectional views showing manufacturing steps of the vibrator according to the second embodiment.

FIGS. 10F1 to 10G2 are cross-sectional views showing manufacturing steps of the vibrator according to the second embodiment.

FIGS. 11H1 to 11I2 are cross-sectional views showing manufacturing steps of the vibrator according to the second embodiment.

FIGS. 12J1 to 12K2 are cross-sectional views showing manufacturing steps of the vibrator according to the second embodiment.

FIGS. 13L1 and 13L2 are cross-sectional views showing manufacturing steps of the vibrator according to the second embodiment.

FIGS. 14A and 14B are perspective views showing a personal computer and a mobile phone, respectively, as electronic apparatuses according to a third embodiment.

FIG. 15 is a perspective view showing a digital still camera as an electronic apparatus according to the third embodiment.

FIG. 16 is a perspective view showing a mobile unit according to a fourth embodiment.

FIGS. 17A and 17B are sectional side elevations of MEMS vibrators according to Modified Example 1 and Modified Example 2, respectively; and FIG. 17C is a conceptual view showing how a movable upper electrode (second electrode) of a MEMS vibrator according to Modified Example 3 vibrates.

FIGS. 18A to 18E are step diagrams showing in order, as Modified Example 4, a modified example of the manufacturing method of the MEMS vibrator.

FIG. 19A is a perspective view showing a support member according to Modified Example 5; and FIG. 19B is a perspective view showing a support member according to Modified Example 6.

### DESCRIPTION OF EXEMPLARY EMBODIMENTS

Embodiments in which the invention is embodied will be described below with reference to the drawings. Each of the embodiments described below is one embodiment of the invention and does not limit the invention. In the drawings described below, components are sometimes shown on a scale different from the actual one for facilitating the description.

### First Embodiment

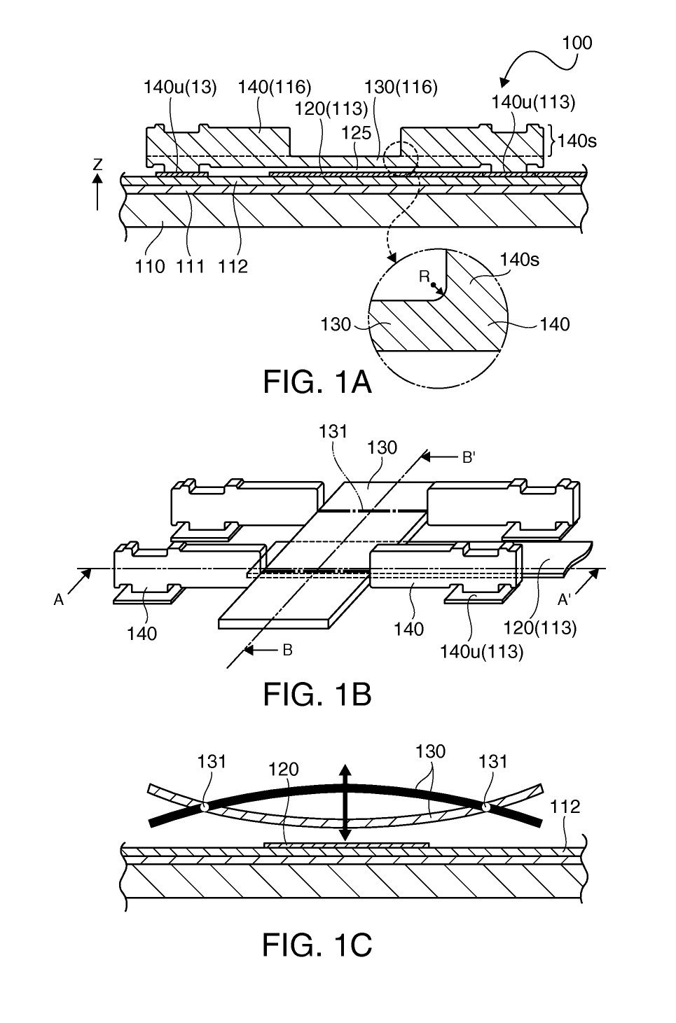

FIG. 1A is a sectional side elevation showing a MEMS vibrator 100 as a vibrator according to a first embodiment. FIG. 1B is a perspective view of the MEMS vibrator 100. FIG. 1A shows a cross-section taken along line A-A′ in FIG. 1B. The MEMS vibrator 100 is a MEMS vibrator including a free-free beam movable electrode that is formed by etching a sacrificial layer stacked on a principal surface of a substrate. The MEMS vibrator 100 is configured to include a wafer substrate 110, a fixed lower electrode 120 as a first electrode, a movable upper electrode 130 as a second electrode, and support members 140. The sacrificial layer is a layer that is removed by etching after forming a necessary layer on, below, or around the sacrificial layer. Due to the removal of the sacrificial layer, a necessary gap or cavity is formed between layers located on, below, or around the sacrificial layer, or a necessary structure is formed in a spaced apart manner.

As a preferred example, a silicon substrate is used for the wafer substrate 110. The fixed lower electrode 120, the movable upper electrode 130, and the support members 140 are formed over a first oxide film 111 and a nitride film 112 that are stacked on the wafer substrate 110. Herein, in a thickness direction of the wafer substrate 110, a direction in which the first oxide film 111 and the nitride film 112 are stacked in order on a principal surface of the wafer substrate 110 is described as an upper direction or a Z-direction as shown in FIG. 1A.

The fixed lower electrode 120 is a fixed electrode patterned into a rectangular shape, and formed by patterning, by photolithography, a lower conductive layer 113 that is stacked on the nitride film 112. The movable upper electrode 130 is a rectangular plate-like movable electrode and formed by patterning, by photolithography, an upper conductive layer 116 that is stacked via a sacrificial layer stacked on the lower conductive layer 113. The movable upper electrode 130 is arranged such that a central region of the movable upper electrode 130 crosses and overlaps the fixed lower electrode 120 when the wafer substrate 110 is planarly viewed. Moreover, the movable upper electrode 130 is joined at four points on side surfaces thereof in the longitudinal direction with two pairs of the support members 140, thereby being supported above the principal surface of the wafer substrate 110. A gap 125 that is formed by removing the sacrificial layer by etching is formed between the movable upper electrode 130 and the fixed lower electrode 120 and between the movable upper electrode 130 and the nitride film 112. Although, as a preferred example, conductive polysilicon is used for each of the lower conductive layer 113 and the upper conductive layer 116, this is not limited thereto.

The support member 140 is a substantially rectangular plate-like body that is obtained by patterning the upper conductive layer 116 by photolithography. The support member 140 is arranged such that the longitudinal direction thereof faces in a direction substantially parallel to the principal surface of the wafer substrate 110 and that the lateral direction thereof faces in the thickness direction of the wafer substrate 110 (a direction substantially vertical to the principal surface). A lower surface of a region of one end of the support member 140 in the longitudinal direction is fixed to the wafer substrate 110 via a fixing portion 140u, the nitride film 112, and the first oxide film 111. Moreover, a side surface of the other end of the support member 140 in the longitudinal direction is joined to the side surface of the movable upper electrode 130 in the longitudinal direction thereof. Moreover, each two of the four support members 140, as two pairs of support members 140, interpose and support the movable upper electrode 130 therebetween. That is, each two of the four support members 140 are located such that the side surfaces (the other ends of the support members 140) of the support members 140 in the lateral direction thereof face each other, and the respective side surfaces of the support members 140 in the lateral direction are joined to the side surfaces of the movable upper electrode 130 in the longitudinal direction of the movable upper electrode.

The length (width of the support member 140 in the Z-direction) of the support member 140 in the lateral direction is formed to be larger than the thickness of the movable upper electrode 130. The support member 140 and the movable upper electrode 130 are joined together at the lowermost portion of the side surface in the lateral direction. That is, the support member 140 has a region (a reinforcing region 140s hereinafter) where the thickness of the support member 140 in the thickness direction (that is, the Z-direction) of the wafer substrate 110 is larger than the thickness of the movable upper electrode 130 in the Z-direction. As shown in FIG. 1A, the reinforcing region 140s is configured such that the thickness of the support member 140 in the Z-direction is larger in a direction away from the principal surface of the wafer substrate 110 than the thickness of the movable upper electrode 130 in the Z-direction. The joint portion between the support member 140 and the movable upper electrode 130 is formed such that they meet at a radius of curvature R as shown by a broken circle in FIG. 1A for an enlargement view. The size of the radius of curvature R is not specifically specified. However, the size is preferably set such that stress from the reinforcing region 140s is not concentrated on the joint portion between the support member 140 and the movable upper electrode 130.

FIG. 1C is a cross-sectional view of the movable upper electrode 130 taken along line B-B′ in FIG. 1B, showing how the movable upper electrode 130 vibrates. In the MEMS vibrator 100, the movable upper electrode 130 vibrates due to an electrostatic force of charge generated by an AC voltage applied between the electrodes (between the fixed lower electrode 120 and the movable upper electrode 130). Between the electrodes, a signal of a natural resonant frequency of the vibrator is output. In FIGS. 1A to 1C, the illustration of electric wiring connected to the fixed lower electrode 120 and the movable upper electrode 130 is omitted. The movable upper electrode 130 performs flexural vibration in which the central portion, at which the fixed lower electrode 120 and the movable upper electrode 130 overlap each other, and both ends of the movable upper electrode 130 serve as antinodes of vibration and nodes of vibration 131 are provided between the antinodes of vibration.

The movable upper electrode 130 is supported at the portions of the nodes of vibration 131 by the support members 140. Specifically, both ends of the node of vibration 131 shown by a chain line in FIG. 1B are supported by the pair of support members 140.

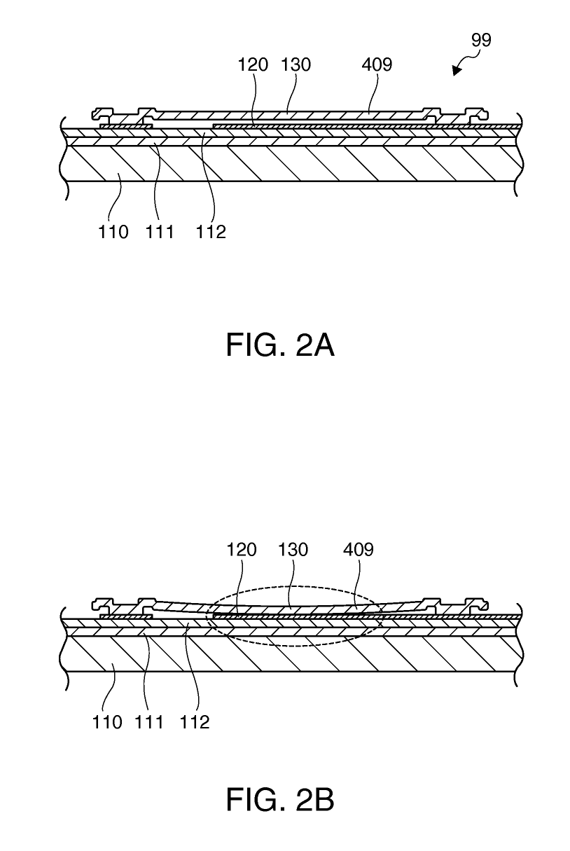

Here, a configuration example of a related-art MEMS vibrator will be described. FIGS. 2A and 2B are sectional side elevations showing a related-art MEMS vibrator 99. The MEMS vibrator 99 is a MEMS vibrator including a free-free beam movable electrode similarly to the MEMS vibrator 100. The MEMS vibrator 99 is configured to include the wafer substrate 110, the fixed lower electrode 120, the movable upper electrode 130, and support members 409. The support member 409 differs from the support member 140 in that the reinforcing region 140s is not included. That is, the thickness of the support member 409 in the Z-direction is the same as the thickness of the movable upper electrode 130 in the Z-direction. Except for this point, the MEMS vibrator 99 is the same as the MEMS vibrator 100.

The support member 409 is formed of the same layer as that forming the movable upper electrode 130. The support member 409 and the movable upper electrode 130 are formed simultaneously by performing patterning by photolithography. Accordingly, they have substantially the same thickness. In general, for responding to downsizing, thinning, power saving, higher frequency, and the like, it is effective to reduce the stiffness of the movable upper electrode or support member, or reduce the gap between the movable upper electrode and the fixed lower electrode. As a result, however, the MEMS vibrator 99 has a problem that sticking of the movable upper electrode 130 to the fixed lower electrode 120 is likely to occur in a manufacturing step as shown in FIG. 2B, thereby failing to obtain sufficient manufacturing yield. The MEMS vibrator 100 addresses such a problem with the above-described configuration.

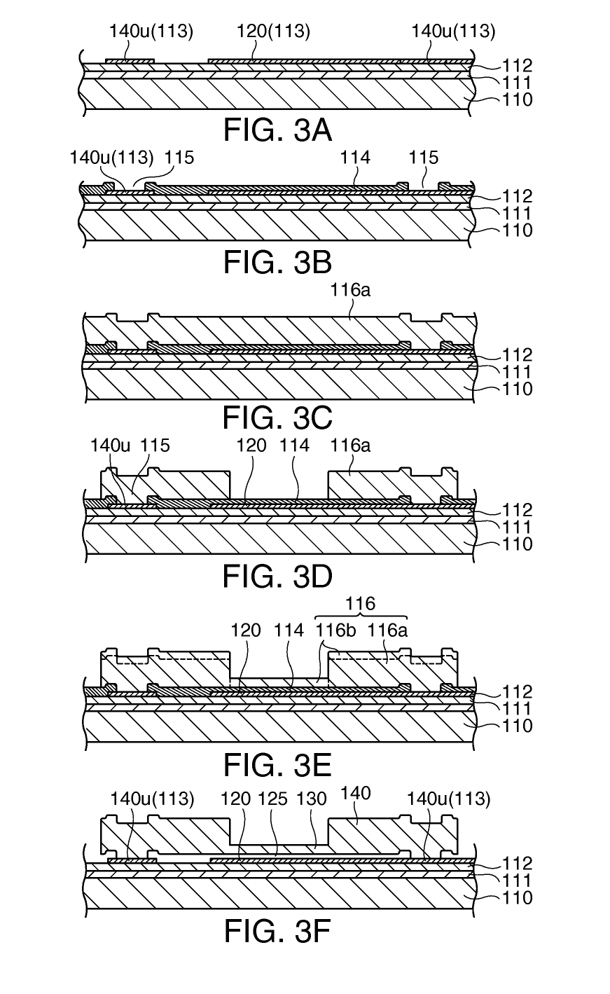

Next, a manufacturing method of the MEMS vibrator 100 will be described. FIGS. 3A to 3F are step diagrams showing in order the manufacturing method of the MEMS vibrator 100. The manufacturing method of the MEMS vibrator 100 includes: a step of stacking a first conductive layer 116a of the upper conductive layer 116 forming the support member 140, or the support member 140 and the movable upper electrode 130; a step of removing at least a portion of the first conductive layer 116a while leaving a region for forming the support members 140; and a step of stacking a second conductive layer 116b of the upper conductive layer 116 forming the support members 140 and the movable upper electrode 130.

The manufacturing method will be specifically described below with reference to FIGS. 3A to 3F in order. FIG. 3A: the wafer substrate 110 is prepared, and the first oxide film 111 is stacked on the principal surface. As a preferred example, the first oxide film 111 is formed of a LOCOS (local oxidation of silicon) oxide film generally used as an element isolation layer in semiconductor processes. However, depending on the generation of semiconductor processes, an oxide film using an STI (shallow trench isolation) method, for example, may be used. Next, the nitride film 112 is stacked. The nitride film 112 is resistant to buffered hydrofluoric acid as an etching solution and functions as an etching stopper. Next, the lower conductive layer 113 is stacked on the nitride film 112. The lower conductive layer 113 is a polysilicon layer that constitutes the fixed lower electrode 120 and the fixing portion 140u. After stacking, the lower conductive layer 113 is implanted with ions to obtain predetermined conductivity. Next, the lower conductive layer 113 is patterned by photolithography to form the fixed lower electrode 120 and the fixing portions 140u.

FIG. 3B: a CVD (chemical vapor deposition) oxide film 114 is stacked and then patterned by photolithography to form openings 115 at each of which a portion of the fixing portion 140u is exposed. The opening 115 is a portion for fixing the support member 140 to the substrate and is a region corresponding to the lower surface of the region of the one end of the support member 140 formed later. The CVD oxide film 114 is removed later by etching as a sacrificial layer, thereby forming the gap 125 between the fixed lower electrode 120 and the movable upper electrode 130 or between the movable upper electrode 130 and the nitride film 112.

FIG. 3C: the first conductive layer 116a is stacked. The first conductive layer 116a is a polysilicon layer and constitutes a first layer of the upper conductive layer 116 forming the support member 140, or the support member 140 and the movable upper electrode 130.

FIG. 3D: the first conductive layer 116a is patterned by photolithography to forma lower layer portion of the support member 140. Specifically, the first conductive layer 116a is removed except for a region for forming the support members 140 when the wafer substrate 110 is planarly viewed. The region corresponding to the lower surface of the region of the one end of the support member 140 is formed by stacking on the fixing portion 140u through the opening 115.

FIG. 3E: the second conductive layer 116b is stacked. The second conductive layer 116b is the same polysilicon layer as the first conductive layer 116a and constitutes a second layer of the upper conductive layer 116 forming the support members 140 and the movable upper electrode 130. Next, the second conductive layer 116b is patterned by photolithography to form upper layer portions of the support members 140 and the movable upper electrode 130. Specifically, the second conductive layer 116b is removed except for regions for forming the support members 140 and the movable upper electrode 130 when the wafer substrate 110 is planarly viewed. The first conductive layer 116a and the second conductive layer 116b are implanted with ions, after stacking, to obtain predetermined conductivity.

Through the stacking and patterning of the first conductive layer 116a and the second conductive layer 116b, the thickness of the support member 140 is the stacked thickness of the first conductive layer 116a and the second conductive layer 116b, while the thickness of the movable upper electrode 130 is the thickness only of the second conductive layer 116b. This difference in thickness forms the reinforcing region 140s (FIG. 1A) of the support member 140.

FIG. 3F: the wafer substrate 110 is exposed to an etching solution to remove by etching the CVD oxide film 114 as a sacrificial layer, thereby forming the gap 125 between the fixed lower electrode 120 and the movable upper electrode 130 or the gap 125 between the movable upper electrode 130 and the nitride film 112. Through the steps described above, the MEMS vibrator 100 is formed. For providing and maintaining favorable vibration characteristics, a MEMS structure including a vibrator like the MEMS vibrator 100 is preferably arranged in a reduced-pressure space. Therefore, it is preferable to form a side wall surrounding the MEMS vibrator 100, a covering layer (sealing layer) covering a space formed by the side wall, a surface protective layer, and the like, by a semiconductor manufacturing process including the above-described steps, to arrange the MEMS vibrator 100 in a cavity in which a reduced-pressure is maintained.

As has been described above, according to the vibrator and the manufacturing method of the vibrator according to the embodiment, the following advantageous effects can be obtained. The support member 140 that supports the movable upper electrode 130 having a region overlapping the fixed lower electrode 120 with the gap 125 has the reinforcing region 140s where the thickness of the support member 140 is larger than the thickness of the movable upper electrode 130 in the Z-direction. With the reinforcing region 140s, the rigidity of the support member 140 in the Z-direction is increased. As a result, even when an external force acts in a direction in which the movable upper electrode 130 approaches the fixed lower electrode 120, the movable upper electrode 130 is less likely to approach the fixed lower electrode 120. Accordingly, in the case where, for example, the sacrificial layer (the CVD oxide film 114) is removed by etching for forming the movable upper electrode 130 and the fixed lower electrode 120, even when the surface tension or the like of an etching solution or cleaning liquid acts between the movable upper electrode 130 and the fixed lower electrode 120, a sticking phenomenon that the movable upper electrode 130 is adhered to the fixed lower electrode 120 is less likely to occur. As a result, a reduction in yield due to the sticking can be suppressed.

The movable upper electrode 130 is a vibrating plate that flexurally vibrates in the Z-direction, and node portions of the flexural vibration (the nodes of vibration 131) of the movable upper electrode 130 are joined to the other ends of the support members 140. The rigidity of the support member 140 is enhanced in the Z-direction with the reinforcing region 140s. Accordingly, even when the rigidity of the support member 140 is increased to increase the stiffness, vibration is not significantly prevented because the support members 140 support the node portions of the vibration of the movable upper electrode 130. That is, the support members 140 more effectively support the movable upper electrode 130 without adversely affecting vibration characteristics, which makes it possible to suppress the sticking phenomenon.

The reinforcing region 140s is composed of a region where the thickness is large in the direction away from the principal surface of the wafer substrate 110 with respect to the support member 140. With this configuration, the rigidity of the support member 140 can be enhanced without changing the size (distance) of the gap 125 between the movable upper electrode 130 and the fixed lower electrode 120. That is, the sticking phenomenon can be suppressed without deteriorating characteristics as a vibrator.

The joint portion between the support member 140 and the movable upper electrode 130 is formed such that they meet at the radius of curvature R. With this configuration, since the concentration of stress from the support member 140 on the joint portion between the support member 140 and the movable upper electrode 130 can be suppressed, the occurrence of a crack at the joint portion caused by vibration or impact can be suppressed.

### Second Embodiment

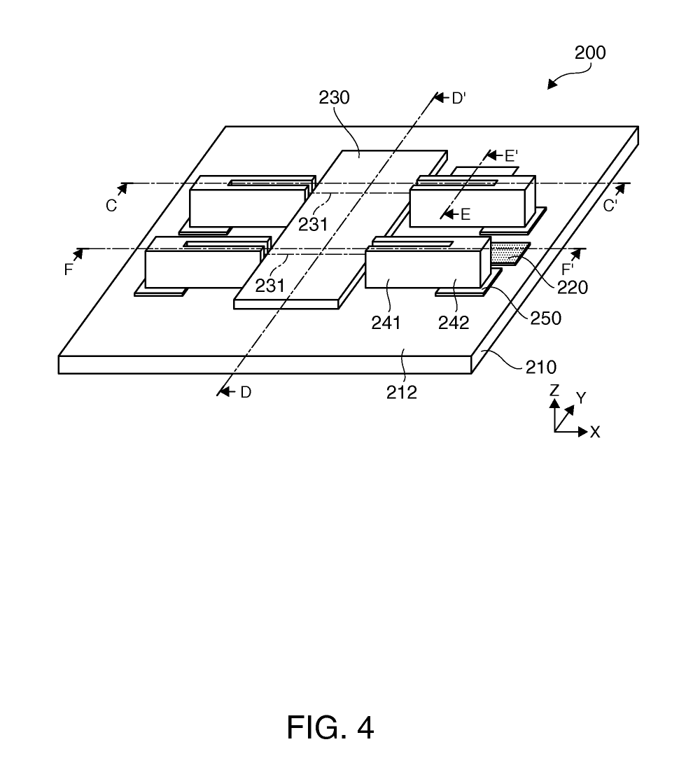

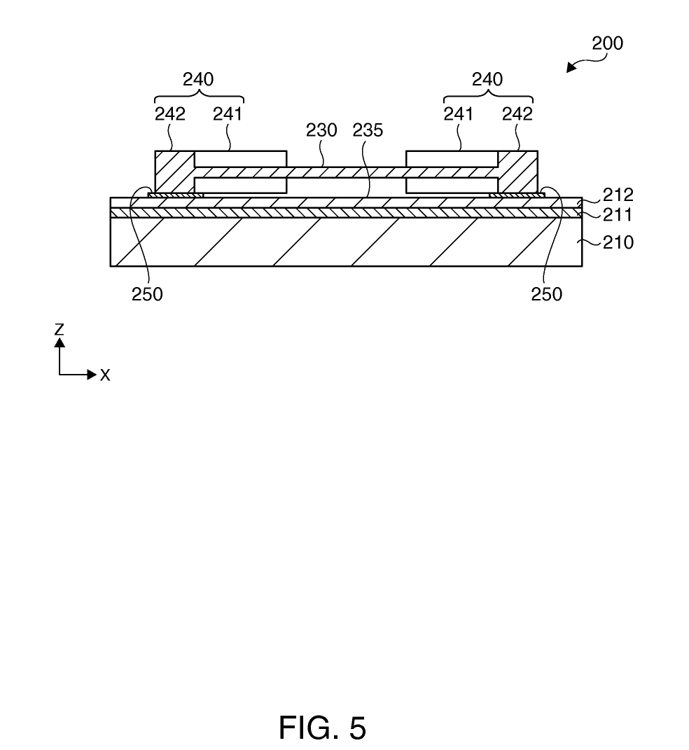

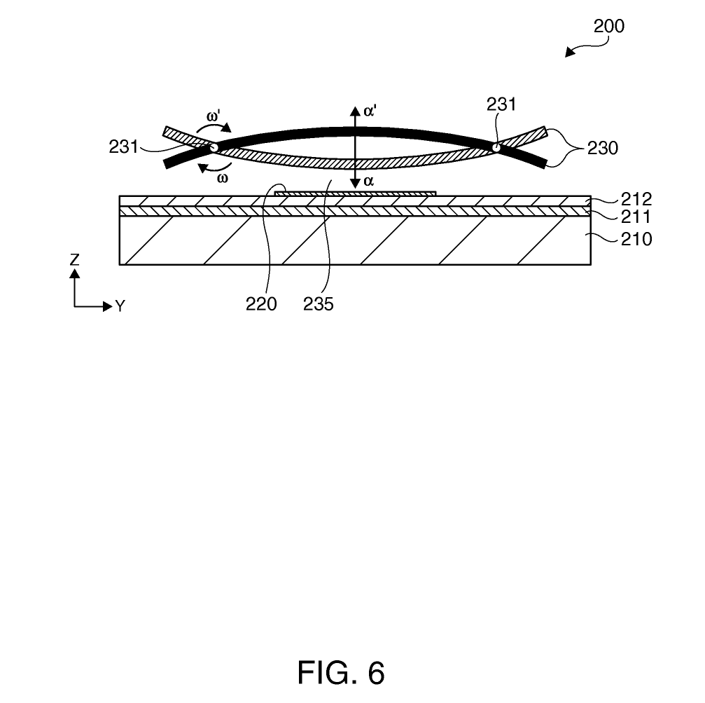

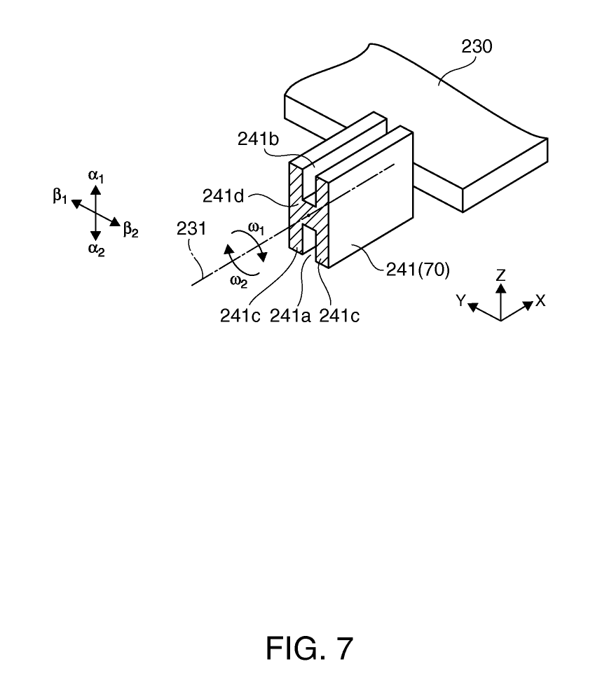

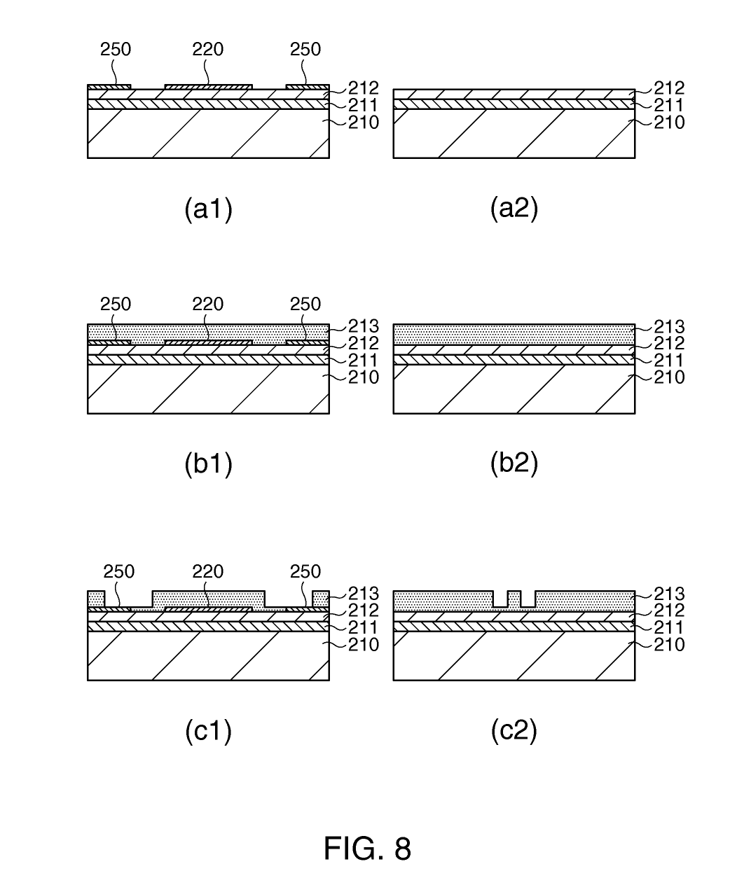

A vibrator according to a second embodiment will be described using FIGS. 4 to 13L2. FIG. 4 is a perspective view schematically showing a MEMS vibrator as a vibrator according to the embodiment. FIG. 5 is a cross-sectional view schematically showing a cross-section of a portion C-C′ of the MEMS vibrator 200 shown in FIG. 4. FIG. 6 is a cross-sectional view schematically showing a cross-section of a portion D-D′ of the MEMS vibrator 200 shown in FIG. 4. FIG. 7 is a perspective view schematically showing by hatching a cross-section of a portion E-E′ of a support member of the MEMS vibrator 200 shown in FIG. 4. FIGS. 8A1 to 13L2 are step diagrams for explaining a manufacturing method of the MEMS vibrator 200 as a vibrator according to the embodiment.

The MEMS vibrator 200 as a vibrator according to the second embodiment has, above a wafer substrate 210, a movable upper electrode 230, support members 240 extended from the movable upper electrode 230, and fixing portions 250 each fixing the support member 240. Moreover, a lower fixed electrode 220 is provided above the wafer substrate 210 for causing the movable upper electrode 230 to vibrate. The support member 240 is configured to include a beam portion 241 and a post portion 242.

In the MEMS vibrator 200, the movable upper electrode 230 is fixed, by the support members 240 extended from the movable upper electrode 230, to the wafer substrate 210 via the fixing portions 250. The support member 240 includes the beam portion 241 extended from the movable upper electrode 230 and the post portion 242 disposed at one end of the beam portion 241 on the side opposite to the movable upper electrode 230. The post portion 242 is connected to the fixing portion 250. In FIG. 4, the movable upper electrode 230 is disposed so as to overlap, with a gap 235, the lower fixed electrode 220 that is disposed above the wafer substrate 210 when viewed planarly from the Z-axis direction shown in the drawing. The movable upper electrode 230 is disposed so as to overlap the lower fixed electrode 220 with the gap 235, thereby being capable of vibrating. Operations of the movable upper electrode 230 will be described later.

The wafer substrate 210 is a base (base material) on which the movable upper electrode 230 and the like are mounted. For the wafer substrate 210, a silicon substrate, which is easily processed by a semiconductor processing technique, is preferably used. The wafer substrate 210 is not limited to a silicon substrate, and a glass substrate, for example, can be used.

As shown in FIG. 5, a first oxide film 211 and a nitride film 212 that is stacked on the first oxide film 211 are disposed on the wafer substrate 210. The lower fixed electrode 220 and the fixing portions 250 are disposed on the nitride film 212.

The first oxide film 211 is disposed on substantially the entire surface of the wafer substrate 210 as viewed from the Z-axis direction shown in FIGS. 4 and 5. As the first oxide film 211, a LOCOS (local oxidation of silicon) film, for example, is used. Moreover, an STI (shallow trench isolation) film or various CVD films can be used. The nitride film 212 is disposed corresponding to (to be stacked on) the first oxide film 211. As the nitride film 212, a silicon nitride (SiN) film, for example, is used.

The lower fixed electrode 220 is disposed on the nitride film 212. The lower fixed electrode 220 is an electrode patterned into, for example, a rectangular shape. As the material of the lower fixed electrode 220, a simple substance of silicon (Si), polysilicon, amorphous silicon, gold (Au), copper (Cu), tungsten (W), titanium (Ti), nickel (Ni), aluminum (Al) or the like, an alloy of these, and the like can be used.

The fixing portion 250 is disposed on the nitride film 212 similarly to the lower fixed electrode 220. More specifically, the fixing portion 250 is disposed by stacking on the nitride film 212. The fixing portion 250 is an electrode patterned into, for example, a rectangular shape. As the material of the fixing portion 250, a simple substance of silicon (Si), polysilicon, amorphous silicon, gold (Au), copper (Cu), tungsten (W), titanium (Ti), nickel (Ni), aluminum (Al) or the like, an alloy of these, and the like can be used similarly to the lower fixed electrode 220.

The movable upper electrode 230 and the support members 240 are disposed above the wafer substrate 210 as viewed from the Z-axis direction shown in FIGS. 4 and 5. The movable upper electrode 230 is disposed to face the lower fixed electrode 220 with the gap 235. The support member 240 is extended from the movable upper electrode 230 toward the fixing portion 250. In the support member 240, the beam portion 241 extended from the movable upper electrode 230 is connected with the post portion 242 disposed at the one end of the beam portion 241 on the side opposite to the movable upper electrode 230, and the post portion 242 is connected to the fixing portion 250. Due to this, the movable upper electrode 230 is connected through the support members 240 to the fixing portions 250, thereby being fixed to the wafer substrate 210. In the MEMS vibrator 200, since the gap 235 is disposed between the movable upper electrode 230 and the lower fixed electrode 220, the movable upper electrode 230 can vibrate.

The movable upper electrode 230 is patterned into, for example, a rectangular shape, has conductivity, and functions as a movable electrode described later. As the material of the movable upper electrode 230, polysilicon (polycrystalline silicon) is used.

FIG. 6 is a cross-sectional view of the MEMS vibrator 200 taken along line D-D′shown in FIG. 4, showing the vibration operation of the movable upper electrode 230. Due to an electrostatic force of charge generated by an AC voltage applied between the lower fixed electrode 220 and the movable upper electrode 230 as a movable electrode, the movable upper electrode 230 is attracted to and separated from the lower fixed electrode 220 in a repetitive manner to thereby perform a bending vibration motion. A signal caused by the vibration is output between the electrodes. The vibration of the movable upper electrode 230 (movable electrode) is a flexural vibration operation in which a central portion, at which the lower fixed electrode 220 and the movable upper electrode 230 overlap each other, and both ends of the movable upper electrode 230 serve as antinodes of vibration and nodes of vibration 231 are provided between the antinodes of vibration. That is to say, the vibration of the movable upper electrode 230 is a bending motion operation with the nodes of vibration 231 each being as a fulcrum. At the node of vibration 231, forces ω and ω′ in the rotational axis direction of the node of vibration 231 are generated. Moreover, in the movable upper electrode 230, forces α and α′ in the Z-axis direction are generated with the vibration motion.

The support members 240 are connected to the movable upper electrode 230 at the portions of the nodes of vibration 231. That is to say, the beam portion 241 is extended from the node of vibration 231 of the movable upper electrode 230. Specifically, the movable upper electrode 230 is supported by the support members 240 at both ends of each of the nodes of vibration 231 shown by a chain line and denoted by the reference numeral 231 in FIG. 4. It is preferable that the support members 240 are extended in opposite directions from the movable upper electrode 230 at each of the nodes of vibration 231 and that the movable upper electrode 230 is supported by two pairs (two sets) of support members 240. The support of the movable upper electrode 230 is not limited thereto, and the support member 240 may be disposed in one direction from the node of vibration 231 of the movable upper electrode 230. Moreover, the support members 240 may be disposed alternately in opposite directions at each of the nodes of vibration 231. Moreover, the support member 240 may be disposed at any of the nodes of vibration 231. Although, in FIG. 4 to FIG. 6, wiring for extracting a signal caused by vibration is disposed on the lower fixed electrode 220 and the movable upper electrode 230 (movable electrode), the description and illustration in each drawing are omitted.

Here, the support member 240 will be described in detail using FIG. 7. FIG. 7 is a perspective view schematically showing by hatching a cross-section of a portion E-E′, shown in FIG. 4, of the beam portion 241 that constitutes the support member 240. The beam portion 241 shown in FIG. 7 shows a cross-section (hatched cross-section shown in a perspective manner) as viewed from a direction in which the beam portion 241 is extended from the movable upper electrode 230. The support member 240 has a portion of a different thickness (the Z-axis direction) between the movable upper electrode 230 and the fixing portion 250, where the support member 240 is extended therebetween. More specifically, as shown in FIG. 7, the beam portion 241 has a recess 241a disposed, for example, in a surface facing the wafer substrate 210 and a recess 241b disposed in an opposite surface. That is to say, the cross-sectional shape of the beam portion 241 is an H-shape.

Since the beam portion 241 of the embodiment has an “H-shape” at the portion of a different thickness, the beam portion 241 has an easy-to-twist characteristic when, for example, forces ω1 and ω2 in the rotational axis direction of the node of vibration 231 are applied to the beam portion 241. For example, compared to the case where the cross-sectional shape of the beam portion 241 is a prismatic shape, the beam portion 241 of the embodiment having an H-shape has an easy-to-twist characteristic. Moreover, since the beam portion 241 has an H-shape, the beam portion 241 has a hard-to-flex (bend) characteristic when, for example, forces in shear directions α₁ and α₂ and shear directions β₁ and β₂ of the beam portion 241 are applied. That is to say, the beam portion 241 includes vertical beams 241c extended in the direction in which the recesses 241a and 241b are disposed, and a horizontal beam 241d serving as bottom surfaces of the recesses 241a and 241b and crossing the vertical beams 241c. Due to this, the vertical beams 241c can suppress the flex of the beam portion 241 in the α₁ and α₂ directions, while the horizontal beam 241d can suppress the flex of the beam portion 241 in the β₁ and β₂ directions.

### Manufacturing Method

Next, a manufacturing method of the MEMS vibrator 200 will be described. FIGS. 8A1 to 13L2 are step diagrams showing the manufacturing method of the MEMS vibrator 200 in the order of steps. The manufacturing method of the MEMS vibrator 200 includes: a step of forming the movable upper electrode 230 and the support members 240; a step of forming the fixing portions 250 and the lower fixed electrode 220; a step of forming an intermediate layer at a portion of the support member 240 where the thickness is made different; and a step of removing the intermediate layer after forming the support members 240.

In FIGS. 8A1 to 13L2, A1 to L1 show the cross-section taken along line F-F′ in FIG. 4, while A2 to L2 show the cross-section taken along line E-E′ in FIG. 4. Moreover, in FIGS. 8A1 to 13L2, when FIG. 8A is referred to for example, it includes FIGS. 8A1 and 8A2 in the following description.

FIG. 8A shows a state where the lower fixed electrode 220 and the fixing portions 250 are disposed above the wafer substrate 210. The formation of the lower fixed electrode 220 and the fixing portions 250 is as follows. The wafer substrate 210 is prepared, and the first oxide film 211 is disposed on a surface serving as a principal surface. As a forming method of the first oxide film 211, a general LOCOS (local oxidation of silicon) film can be formed using a CVD (chemical vapor deposition) method, for example. Next, the nitride film 212 is stacked corresponding to the first oxide film 211. As a forming method of the nitride film 212, a silicon nitride (SiN) film can be formed using a CVD method, for example. The nitride film 212 using a silicon nitride film is resistant to a cleaning liquid (etchant) including hydrofluoric acid and can function as a so-called etching stopper. Next, the lower fixed electrode 220 and the fixing portions 250 are formed on the nitride film 212. As a forming method of the lower fixed electrode 220 and the fixing portions 250, a conductive film can be disposed using a photolithography method, for example.

FIG. 8B shows a state where a first sacrificial layer 213 as an intermediate layer for disposing the gap 235 (refer to FIGS. 4 and 5) at the portion of a different thickness of the support member 240 (refer to FIGS. 4 and 5) and between the lower fixed electrode 220 and the movable upper electrode 230. The first sacrificial layer 213 is formed by stacking on the nitride film 212, or on the nitride film 212, the lower fixed electrode 220, and the fixing portion 250. The first sacrificial layer 213 is temporarily disposed for disposing the gap 235 between the movable upper electrode 230 and a portion of the support member 240, and the nitride film 212, the lower fixed electrode 220, and the fixing portion 250. As a forming method of the first sacrificial layer 213, a silicon oxide (SiO₂) film can be disposed using a CVD method, for example. Since a first silicon layer (film) 214, which is stacked on the first sacrificial layer 213 in a later step to be the movable upper electrode 230 and the support member 240, is formed on the first sacrificial layer 213, planarization is performed on a surface of the first sacrificial layer 213. The planarization of the first sacrificial layer 213 can be performed by, for example, a CMP (chemical mechanical polishing) method.

FIG. 8C shows a state where the first sacrificial layer 213 is removed (etched) for forming portions at each of which the support member 240 is connected to the fixing portion 250 and the portion of a different thickness of the support member 240. Specifically, FIG. 8C1 shows a state where the first sacrificial layer 213 at portions each serving as the fixing portion 250 that fixes the post portion 242 of the support member 240 is removed to expose the fixing portion 250. FIG. 8C2 shows a state where the first sacrificial layer 213 is removed at the beam portion 241 serving as the portion of a different thickness of the support member 240, that is, a portion serving as the recess 241a. The partial removal of the first sacrificial layer 213 can be performed by a photolithography method.

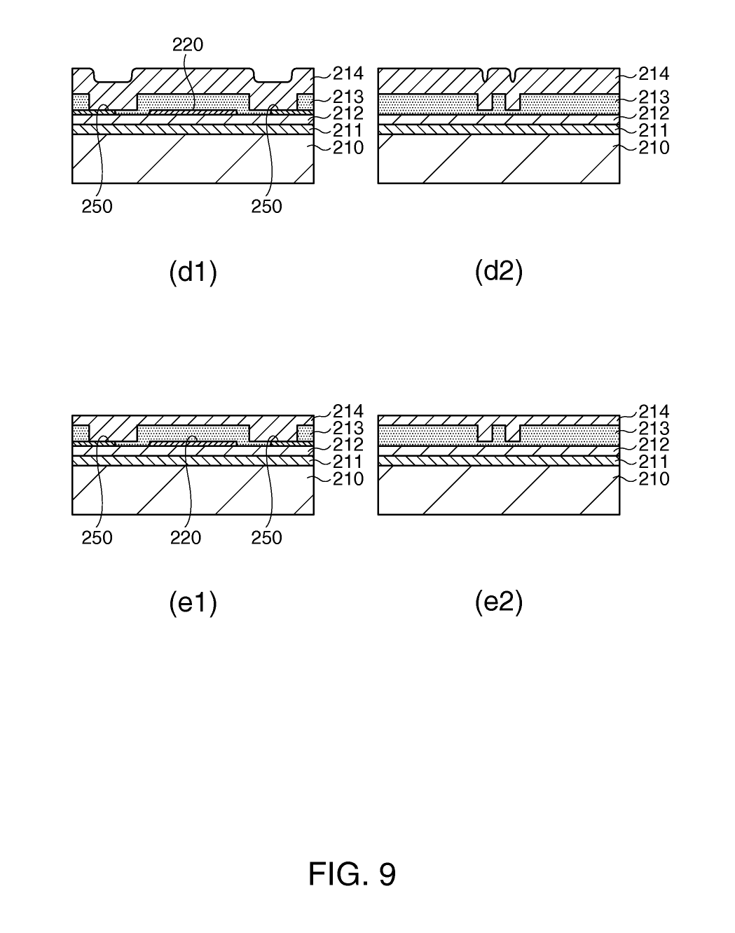

FIG. 9D shows a state where the first silicon layer 214 serving as the movable upper electrode 230 and the support members 240 is formed. The first silicon layer 214 is formed corresponding to the first sacrificial layer 213 or to the first sacrificial layer 213 and the fixing portions 250. As a forming method of the first silicon layer 214, a polysilicon layer can be disposed using a CVD method, for example.

FIG. 9E shows a state where the first silicon layer 214 is planarized. Since the first silicon layer 214 is formed to include the portions at which the first sacrificial layer 213 is removed as described above, a depression (recess) is generated at the portions at which the first sacrificial layer 213 is removed. When the depression is generated, the thickness of a later-described second silicon layer 216 that is formed by staking on the first silicon layer 214 becomes uneven, which involves a risk that the thicknesses of the movable upper electrode 230 and the support member 240 formed of the first silicon layer 214 and the second silicon layer 216 become uneven. Because of this, the planarization of the first silicon layer 214 is performed. The planarization of the first silicon layer 214 can be performed by a CMP method similarly to the planarization of the first sacrificial layer 213 described above.

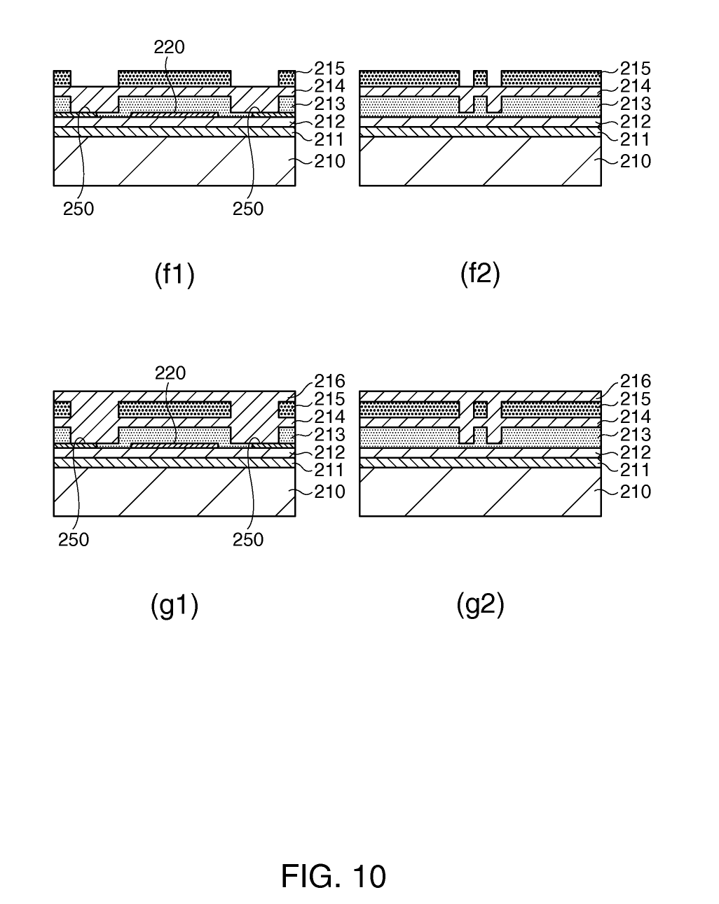

FIG. 10F shows a state where a second sacrificial layer 215 as an intermediate layer is formed and the second sacrificial layer 215 is removed at portions at each of which the support member 240 is formed. The portions at which the second sacrificial layer 215 is removed are the beam portion 241 and the recess 241b that is formed in the beam portion 241. As a forming method of the second sacrificial layer 215, a silicon oxide film can be formed using a CVD method, for example. The partial removal of the second sacrificial layer 215 is performed by, for example, a photolithography method.

FIG. 10G shows a state where the second silicon layer 216 serving as the support member 240 is formed. The second silicon layer 216 is formed by staking on a portion at which the second sacrificial layer 215 is partially removed to expose the first silicon layer 214 and on the second sacrificial layer 215. As a forming method of the second silicon layer 216, a polysilicon film can be formed using a CVD method for example, similarly to the first silicon layer 214.

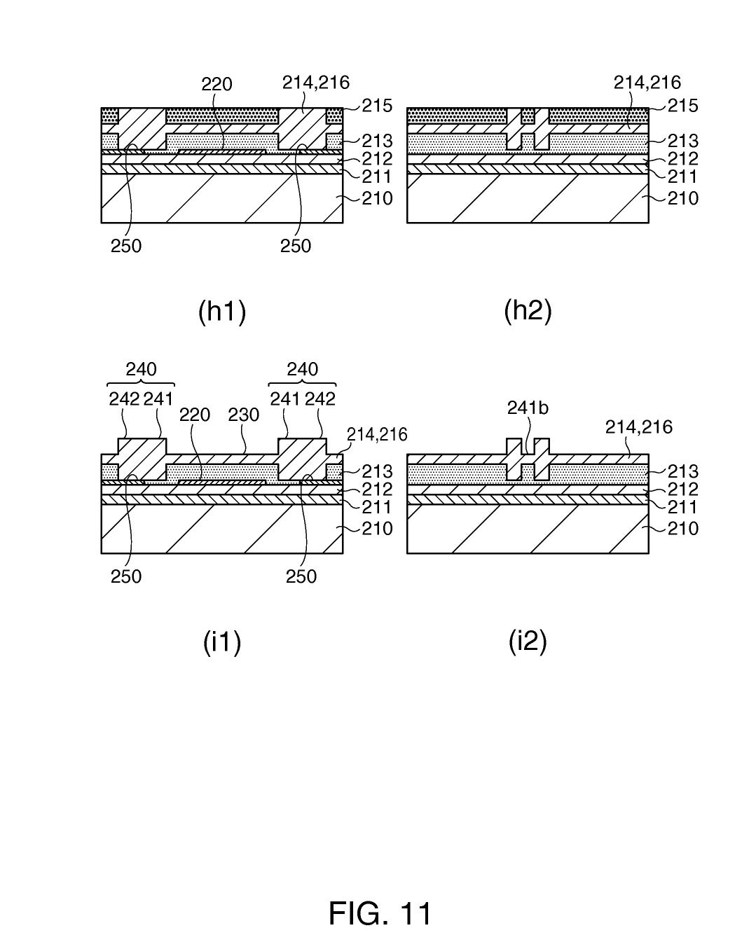

FIG. 11H shows a state where portions of the second silicon layer 216 are ground so that the support member 240 has a predetermined thickness. The grinding of the second silicon layer 216 is performed such that the beam portion 241 and the post portion 242 that constitute the support member 240 have a predetermined thickness. The grinding of the second silicon layer 216 can be performed by a CMP method similarly to the planarization of the first silicon layer 214.

FIG. 11I shows a state where the second sacrificial layer 215 is removed. The removal of the second sacrificial layer 215 can be performed by, for example, protecting the beam portion 241 and the post portion 242 that are exposed from the second sacrificial layer 215 and constitute the support member 240 with a mask pattern or the like using a photolithography method, and removing the second sacrificial layer 215 using a wet etching method. With the removal of the second sacrificial layer 215, the shapes of a portion of the post portion 242 and the recess 241b that is formed in the beam portion 241 appear.

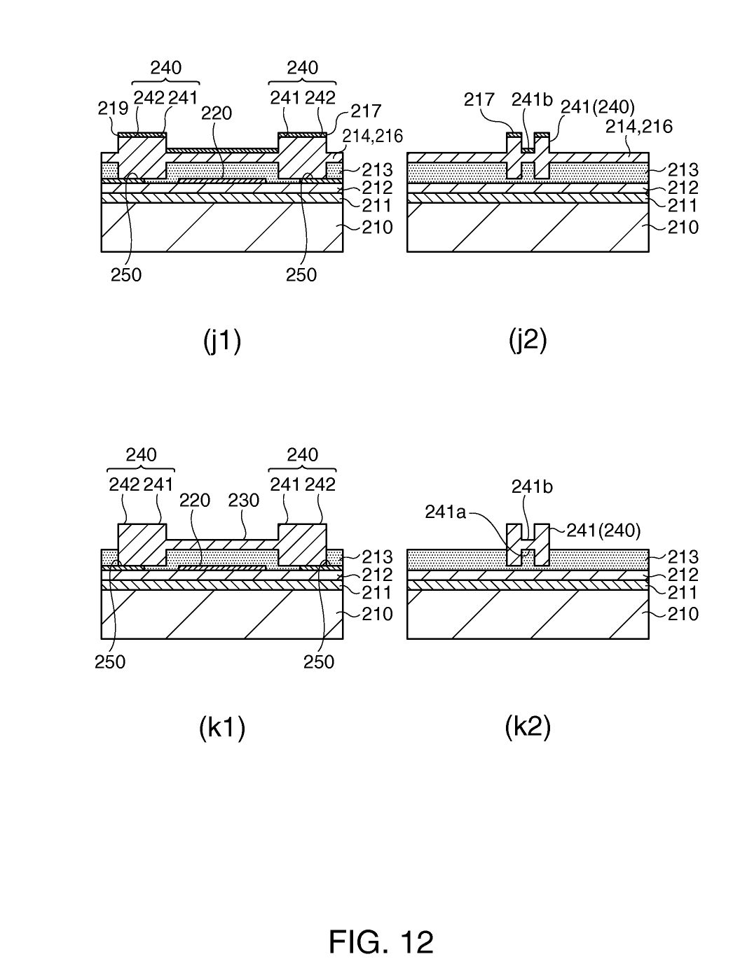

FIG. 12J shows a state where the second silicon layer 216 is patterned with a resist film 217 for forming the shapes of the movable upper electrode 230 and the support members 240. On the second silicon layer 216, the resist film 217 is formed at portions necessary as the movable upper electrode 230 and the support members 240. Due to this, the second silicon layer 216 and the first silicon layer 214 therebelow at portions not formed with the resist film 217 are removed, which makes it possible to form the movable upper electrode 230 and the support member 240. The removal of the first silicon layer 214 and the second silicon layer 216 can be performed by, for example, a photolithography method. FIG. 12K shows a state where the portions of the first silicon layer 214 and the second silicon layer 216 are removed through the above-described step and portions of the shapes of the movable upper electrode 230 and the support members 240 appear. The removal of the first silicon layer 214 and the second silicon layer 216 can be performed by, for example, a wet etching method using an etching solution (etchant) that selectively etches only polysilicon that constitutes the first silicon layer 214 and the second silicon layer 216.

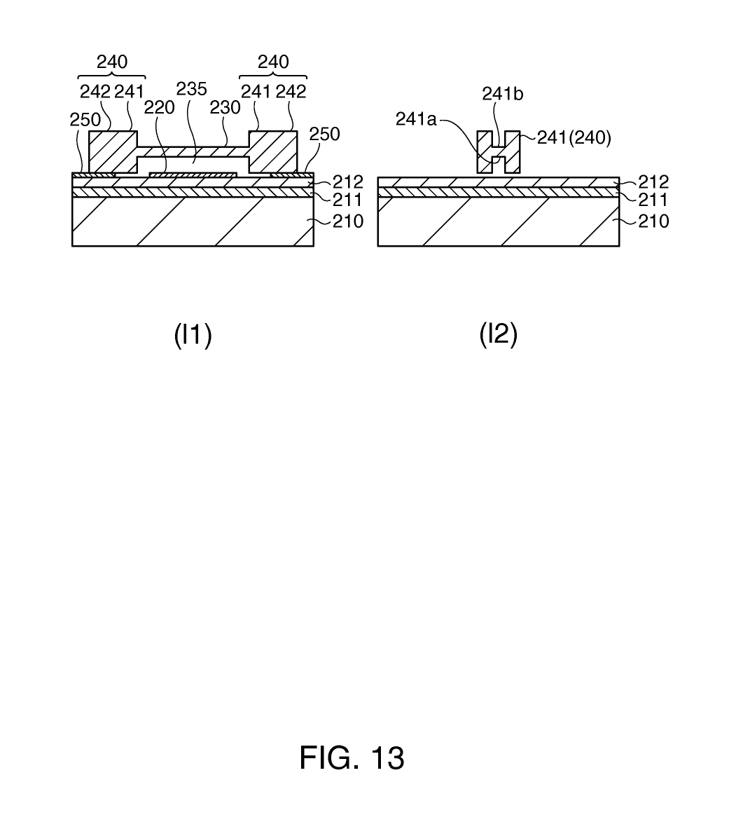

FIG. 13L shows a state where the first sacrificial layer 213 is removed and the shapes of the movable upper electrode 230 and the support member 240 appear. The removal of the first sacrificial layer 213 can be performed by, for example, a wet etching method using an etching solution (etchant) that can selectively etch the first sacrificial layer 213. As an etching solution, an etching solution including hydrofluoric acid can be used. With the use of such an etching solution, the first sacrificial layer 213 formed of a silicon oxide film can be selectively removed (etched), while the first oxide film 211 formed of a LOCOS film can be protected by the nitride film 212 formed of a silicon nitride film. With the completion of the removal of the first sacrificial layer 213, the manufacturing steps of the MEMS vibrator 200 are completed.

According to the embodiment described above, the following advantageous effects are obtained. According to the MEMS vibrator 200, the support member 240 has the beam portion 241 as a portion of a different thickness. With the beam portion 241, the force of ω in the rotational axis direction of the support member 240 caused by the vibration of the movable upper electrode 230, that is, the twisting of the beam portion 241 can be allowed. Therefore, the support member 240 can maintain its rigidity by reducing the thickness of the beam portion 241 without reducing the thickness of the entire support member 240. Moreover, since the portion of a different thickness is twisted with the vibration of the movable upper electrode 230 irrespective of the length of the beam portion 241, restriction on the vibration can be suppressed. Accordingly, since the portion of a different thickness of the support member 240, that is, the beam portion 241 is twisted, it is possible to improve vibration characteristics and suppress the sticking of the movable upper electrode 230 caused by the flex of the support member 240.

According to the manufacturing method of the MEMS vibrator 200, the first sacrificial layer 213 and the second sacrificial layer 215 are formed as intermediate layers, which makes it possible to dispose the intermediate layers at the portion of a different thickness, that is, the beam portion 241 in forming the support member 240. Moreover, the intermediate layers are formed in the depressions of the recesses 241a and 241b, and the intermediate layers are removed after forming the support member 240. Therefore, the movable upper electrode 230 and the support members 240 are integrally formed, and the portion of a different thickness, that is, the recesses 241a and 241b can be formed in the beam portion 241.

### Third Embodiment

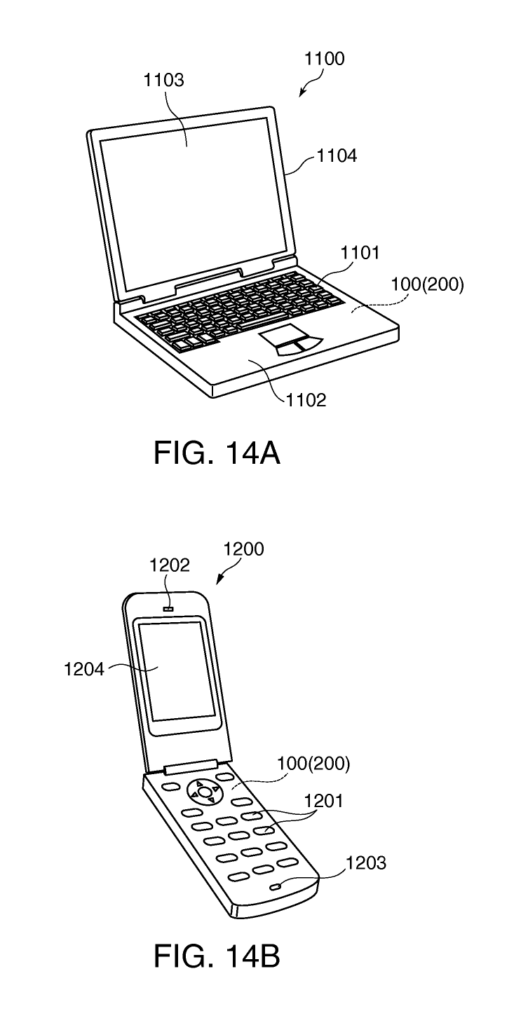

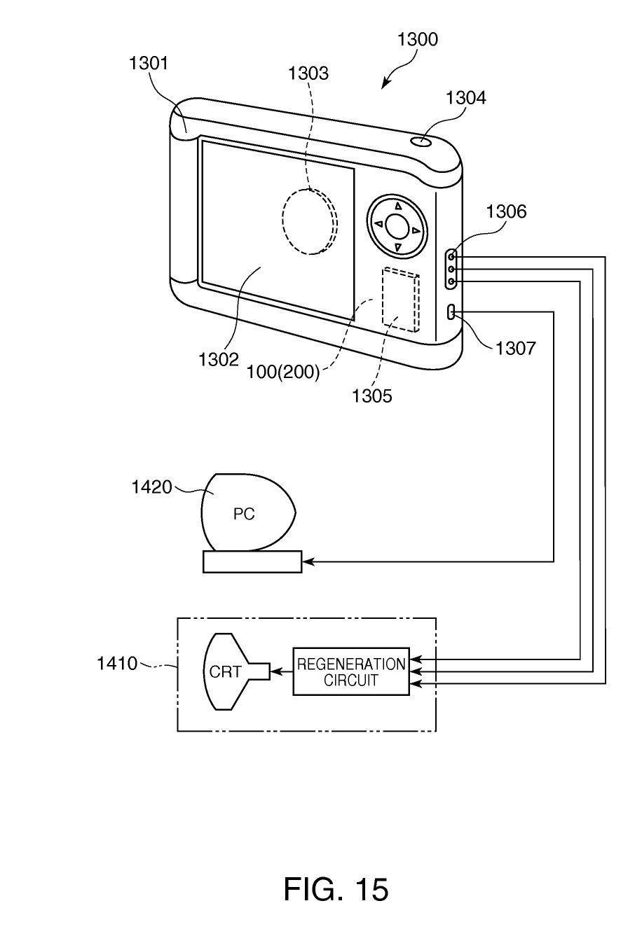

As a third embodiment, electronic apparatuses to which the MEMS vibrator 100 according to the first embodiment or the MEMS vibrator 200 according to the second embodiment is applied as an electronic component according to an embodiment of the invention will be described based on FIGS. 14A to 15.

FIG. 14A is a perspective view showing a schematic configuration of a mobile (or notebook) personal computer as an electronic apparatus including an electronic component according to an embodiment of the invention. In the drawing, the personal computer 1100 is composed of a main body portion 1102 including a keyboard 1101 and a display unit 1104 including a display portion 1103. The display unit 1104 is rotatably supported relative to the main body portion 1102 via a hinge structure portion. In the personal computer 1100, the MEMS vibrator 100 or the MEMS vibrator 200 as an electronic component that functions as a filter, a resonator, a reference clock, or the like is incorporated.

FIG. 14B is a perspective view showing a schematic configuration of a mobile phone (including a PHS) as an electronic apparatus including an electronic component according to an embodiment of the invention. In the drawing, the mobile phone 1200 includes a plurality of operation buttons 1201, an earpiece 1202, and a mouthpiece 1203. A display portion 1204 is arranged between the operation buttons 1201 and the earpiece 1202. In the mobile phone 1200, the MEMS vibrator 100 or the MEMS vibrator 200 as an electronic component (timing device) that functions as a filter, a resonator, an angular velocity sensor, or the like is incorporated.

FIG. 15 is a perspective view showing a schematic configuration of a digital still camera as an electronic apparatus including the MEMS vibrator 100 according to the first embodiment or the MEMS vibrator 200 according to the second embodiment as an electronic component according to an embodiment of the invention. In the drawing, connections with external apparatuses are also shown in a simplified manner. The digital still camera 1300 photoelectrically converts an optical image of a subject with an imaging element such as a CCD (charge coupled device) to generate imaging signals (image signals).

A display portion 1302 is disposed on the back surface of a case (body) 1301 in the digital still camera 1300 and configured to perform display based on imaging signals generated by a CCD. The display portion 1302 functions as a finder that displays a subject as an electronic image. Moreover, on the front side (the rear side in the drawing) of the case 1301, a light receiving unit 1303 including an optical lens (imaging optical system) and a CCD is disposed. When a photographer confirms a subject image displayed on the display portion 1302 and presses down a shutter button 1304, imaging signals of a CCD at the time are transferred to and stored in a memory 1305. In the digital still camera 1300, a video signal output terminal 1306 and a data communication input/output terminal 1307 are disposed on the side surface of the case 1301. Then, as shown in the drawing, a television monitor 1410 and a personal computer 1420 are connected as necessary to the video signal output terminal 1306 and the data communication input/output terminal 1307, respectively. Further, the imaging signals stored in the memory 1305 are output to the television monitor 1410 or the personal computer 1420 by a predetermined operation. In the digital still camera 1300, the MEMS vibrator 100 or the MEMS vibrator 200 as an electronic component that functions as a filter, a resonator, an angular velocity sensor, or the like is incorporated.

As described above, by utilizing, as an electronic component, the MEMS vibrator 100 or the MEMS vibrator 200 that achieves stabilized high manufacturing yield without deteriorating higher performance characteristics, it is possible to provide an electronic apparatus having higher performance at a low price.

The MEMS vibrator 100 or the MEMS vibrator 200 as an electronic component according to an embodiment of the invention can be applied to those other than the personal computer (mobile personal computer) in FIG. 14A, the mobile phone in FIG. 14B, and the digital still camera in FIG. 15. Examples of application include electronic apparatuses such as inkjet ejection apparatuses (for example, inkjet printers), laptop personal computers, television sets, video camcorders, car navigation systems, pagers, electronic notebooks (including those with communication function), electronic dictionaries, calculators, electronic gaming machines, workstations, videophones, surveillance television monitors, electronic binoculars, POS terminals, medical equipment (for example, electronic thermometers, sphygmomanometers, blood glucose meters, electrocardiogram measuring systems, ultrasonic diagnosis apparatuses, and electronic endoscopes), fishfinders, various kinds of measuring instrument, indicators (for example, indicators used in vehicles, aircraft, and ships), and flight simulators.

### Fourth Embodiment

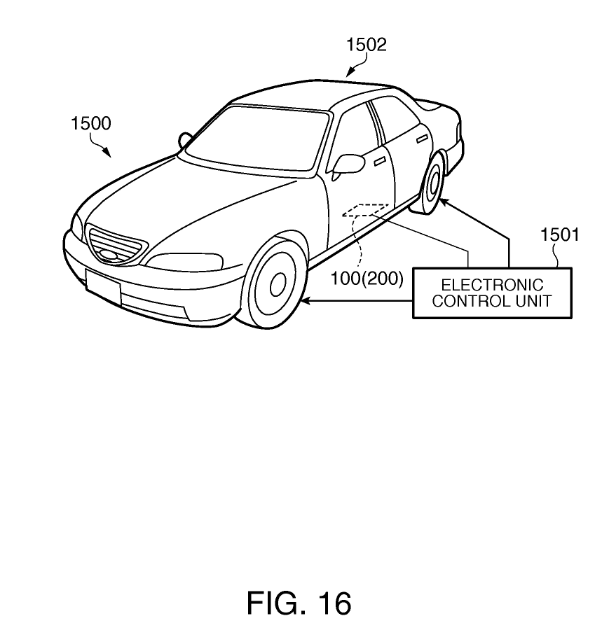

As a fourth embodiment, a mobile unit to which the MEMS vibrator 100 or the MEMS vibrator 200 is applied as an electronic component according to an embodiment of the invention will be described using FIG. 16. FIG. 16 is a perspective view schematically showing an automobile as an exemplary mobile unit. The automobile 1500 includes the MEMS vibrator 100 according to the embodiment of the invention. For example as shown in the drawing, in the automobile 1500 as a mobile unit, an electronic control unit (ECU) 1501 that incorporates therein, as a sensor that detects acceleration of the automobile 1500, the MEMS vibrator 100 or the MEMS vibrator 200 to control an output of an engine is mounted on an automobile body 1502. In addition, the MEMS vibrator 100 or the MEMS vibrator 200 can be widely applied to automobile body attitude control units, anti-lock brake systems (ABSs), air bags, and tire pressure monitoring systems (TPMSs).

As described above, by applying the MEMS vibrator 100 or the MEMS vibrator 200 according to the embodiment of the invention to a mobile unit, it is possible to provide a mobile unit having higher performance and capable of realizing a stable running.

The invention is not limited to the embodiments described above, and various modifications and improvements can be added to the embodiments. Modified examples will be described below. The same constituent portions as those of the embodiments are denoted by the same reference numerals and signs, and the repetitive description is omitted.

### Modified Example 1

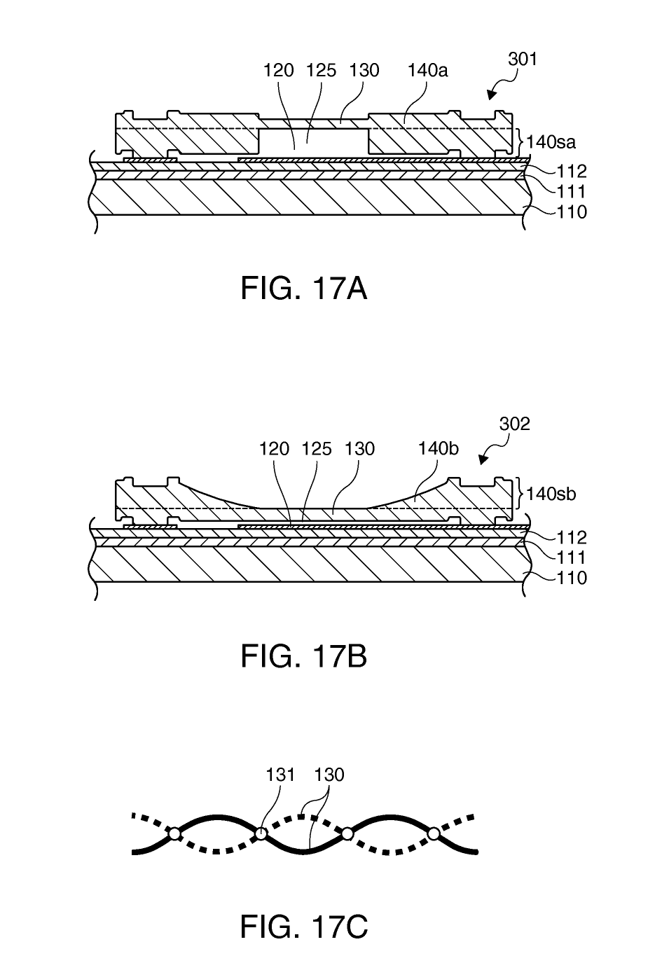

FIG. 17A is a sectional side elevation of a MEMS vibrator 301 according to Modified Example 1 as a modified example of the MEMS vibrator 100 according to the first embodiment. The MEMS vibrator 301 is a MEMS vibrator including a free-free beam movable electrode similarly to the MEMS vibrator 100. The MEMS vibrator 301 is configured to include the wafer substrate 110, the fixed lower electrode 120, the movable upper electrode 130, and support members 140a. The support member 140a differs from the support member 140 in that a reinforcing region 140sa that is different in position from the reinforcing region of the support member 140 is included. In the MEMS vibrator 100, the reinforcing region 140s is configured such that the thickness of the support member 140 in the Z-direction is larger in the direction away from the principal surface of the wafer substrate 110 than the thickness of the movable upper electrode 130 in the Z-direction. In contrast to this, the reinforcing region 140sa is configured in the MEMS vibrator 301 such that the thickness of the support member 140a in the Z-direction is larger in a direction close to the principal surface of the wafer substrate 110 than the thickness of the movable upper electrode 130 in the Z-direction. That is to say, the movable upper electrode 130 is supported at the lower portion of the support member 140 in the MEMS vibrator 100, whereas the movable upper electrode 130 is supported at the upper portion of the support member 140 in the MEMS vibrator 301. Except for this point, the MEMS vibrator 301 is the same as the MEMS vibrator 100.

As in the MEMS vibrator 301 according to Modified Example 1, when the size of the gap 125 originally has room to arrange the reinforcing region 140sa for obtaining a desired vibration characteristic, the support member can be reinforced by locating the reinforcing region 140sa lower than the position of the movable upper electrode 130 without changing the thickness (height) of the MEMS vibrator 301.

### Modified Example 2

FIG. 17B is a sectional side elevation of a MEMS vibrator 302 according to Modified Example 2 as a modified example of the MEMS vibrator 100 according to the first embodiment. The MEMS vibrator 302 is a MEMS vibrator including a free-free beam movable electrode similarly to the MEMS vibrator 100. The MEMS vibrator 302 is configured to include the wafer substrate 110, the fixed lower electrode 120, the movable upper electrode 130, and support members 140b. The support member 140b differs from the support member 140 in that a reinforcing region 140sb that is different in shape from the reinforcing region of the support member 140 is included. The shape of the reinforcing region 140sb is such that the thickness of the reinforcing region 140sb in the Z-direction increases in the upper direction (direction away from the principal surface of the wafer substrate 110) with distance from a portion (the other end of the support member 140b) joined to the movable upper electrode 130. Except for this point, the MEMS vibrator 302 is the same as the MEMS vibrator 100.

As in Modified Example 2, the thickness of the reinforcing region 140sb in the Z-direction increases with distance from the portion joined to the movable upper electrode 130. With this configuration, the concentration of stress from the support member 140b on the joint portion between the support member 140b and the movable upper electrode 130 can be suppressed. Therefore, a crack at the joint portion caused by vibration or impact can be reduced.

### Modified Example 3

FIG. 17C is a conceptual view showing how the movable upper electrode 130 of a MEMS vibrator 303 (not shown) according to Modified Example 3 as a modified example of the MEMS vibrator 100 according to the first embodiment vibrates. The MEMS vibrator 303 is a MEMS vibrator including a free-free beam movable electrode similarly to the MEMS vibrator 100. The MEMS vibrator 303 is configured to include the wafer substrate 110, the fixed lower electrode 120, the movable upper electrode 130, and the support members 140. As shown in FIG. 1B, the MEMS vibrator 100 has been described in which the movable upper electrode 130 is supported by the two pairs of support members 140. However, the number of pairs of the support member 140 is not limited to two. For example, when there are four nodes of vibration 131 in vibration as shown in FIG. 17C, the movable upper electrode 130 may be configured to be supported by four pairs of support members 140. That is, when the number of nodes of vibration 131 is three or more, the movable upper electrode 130 may be configured to be supported by the support members 140 whose number of pairs is up to the number of the nodes of vibration 131.

As in Modified Example 3, since the movable upper electrode 130 is supported at a plurality of points by the pair of support members and therefore the rigidity in the Z-direction is more increased, the sticking phenomenon is effectively suppressed. Moreover, since the movable upper electrode 130 is supported by the pair of support members at both ends of the portion of the node of vibration 131 of the movable upper electrode 130, vibration characteristics of the movable upper electrode 130 are not significantly deteriorated.

### Modified Example 4

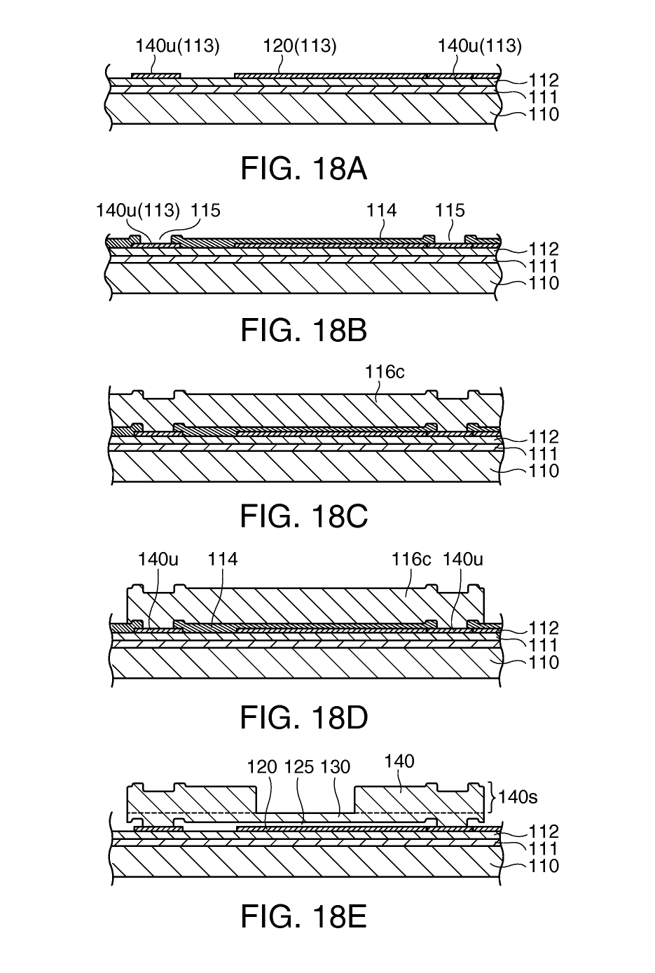

FIGS. 18A to 18E show Modified Example 4 as a modified example of the MEMS vibrator 100 according to the first embodiment, and are step diagrams showing in order a modified example of the manufacturing method of the MEMS vibrator 100. The manufacturing method of Modified Example 4 includes: a step of stacking a conductive layer for forming the support members 140 and the movable upper electrode 130; and a step of removing a portion of the conductive layer while leaving a region for forming the support members 140. Steps described with reference to FIGS. 18A and 18B are similar to those of FIGS. 3A and 3B. Hereinafter, FIGS. 18C to 18E will be described in order.

FIG. 18C: a first conductive layer 116c is stacked. The first conductive layer 116c is a polysilicon layer and a layer forming the support members 140 and the movable upper electrode 130. The step of stacking the first conductive layer 116c is the same as the step of stacking the first conductive layer 116a, but the thickness of the first conductive layer 116c to be stacked is different. In the manufacturing method described in the first embodiment, the support member 140 is formed by stacking the first conductive layer 116a and the second conductive layer 116b as shown in FIG. 3E. In the manufacturing method according to Modified Example 4, however, the support member 140 is formed of the first conductive layer 116c.

FIG. 18D: the first conductive layer 116c is patterned by photolithography to forma portion serving as the movable upper electrode 130 and the support members 140. Specifically, the first conductive layer 116c is removed except for regions for forming the movable upper electrode 130 and the support members 140 when the wafer substrate 110 is planarly viewed. A region corresponding to the lower surface of the region of the one end of the support member 140 is formed by stacking at the fixing portion 140u through the opening 115.

FIG. 18E: the left first conductive layer 116c is further patterned by photolithography to form a portion serving as the movable upper electrode 130. Specifically, the first conductive layer 116c is half-etched in the region of the movable upper electrode 130 except for the region of the support members 140 when the wafer substrate 110 is planarly viewed. The half-etching is finished when the thickness of the movable upper electrode 130 reaches a desired thickness.

FIG. 18E: the wafer substrate 110 is exposed to an etching solution to remove by etching the CVD oxide film 114 as a sacrificial layer, thereby forming the gap 125 between the fixed lower electrode 120 and the movable upper electrode 130, or the gap 125 between the movable upper electrode 130 and the nitride film 212. Through the steps described above, the MEMS vibrator 100 is formed.

According to the manufacturing method of Modified Example 4, the first conductive layer 116c stacked in the region for forming the support member 140 is left without being selectively removed, which makes it possible to form the reinforcing region 140s in the support member 140. As a result, the vibrator described above can be simply manufactured.

### Modified Example 5

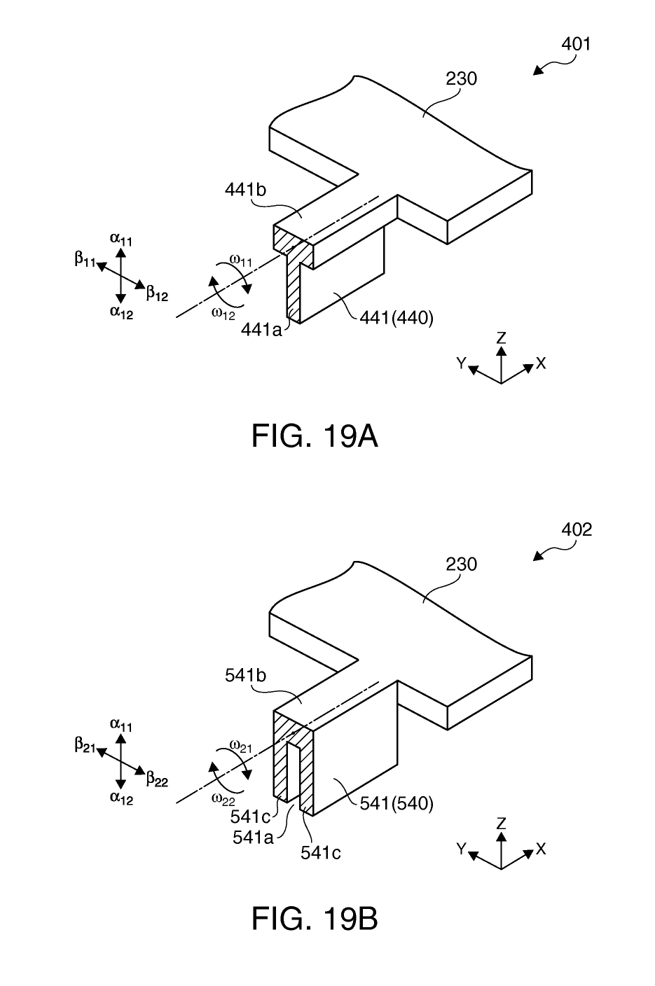

FIG. 19A is a perspective view showing by hatching a cross-section of a support member 440 of a MEMS vibrator 401 according to Modified Example 5 as a modified example of the MEMS vibrator 200 according to the second embodiment. The MEMS vibrator 401 is a MEMS vibrator including a free-free beam movable electrode similarly to the MEMS vibrator 200. The MEMS vibrator 401 is configured to include the wafer substrate 210, the lower fixed electrode 220, the movable upper electrode 230, the fixing portions 250, and the support members 440. In FIG. 19A, the illustration of them is partially omitted. The support member 440 differs from the support member 240 of the MEMS vibrator 200 in the shape of a beam portion 441. The beam portion 441 has a portion of a different thickness (the Z-axis direction) between the movable upper electrode 230 and the fixing portion 250, where the support member 440 is extended therebetween. More specifically, the beam portion 441 includes, as the portion of a different thickness, a vertical beam 441a extended in a direction in which the movable upper electrode 230 vibrates, and a horizontal beam 441b extended in a direction perpendicular to the vertical beam 441a. That is to say, the beam portion 441 has a “T-shape”.

Since the beam portion 441 has a T-shape at the portion of a different thickness, the beam portion 441 has an easy-to-twist characteristic when, for example, forces in rotational axis directions ω₁₁ and ω₂₁ of the beam portion 441 are applied. For example, compared to the case where the beam portion 441 has a prismatic shape, the beam portion 441 having a T-shape has an easy-to-twist characteristic. Moreover, since the beam portion 441 has a T-shape, the beam portion 441 has a hard-to-flex (bend) characteristic when, for example, forces in shear directions α₁ₗ and α₁₂ and shear directions β₁₁ and β₁₂ of the beam portion 441 are applied. That is to say, the horizontal beam 441b can suppress the flex of the beam portion 441 in the β₁₁ and β₁₂ directions, while the vertical beam 441a can suppress the flex of the beam portion 441 in the α₁₁ and α₁₂ directions. Accordingly, the sticking of the movable upper electrode 230 can be suppressed. The other points are similar to those of the MEMS vibrator 200, and therefore, the description is omitted.

### Modified Example 6

FIG. 19B is a perspective view showing by hatching a cross-section of a support member 540 of a MEMS vibrator 402 according to Modified Example 6 as a modified example of the MEMS vibrator 200 according to the second embodiment. The MEMS vibrator 402 is a MEMS vibrator including a free-free beam movable electrode similarly to the MEMS vibrator 200. The MEMS vibrator 402 is configured to include the wafer substrate 210, the lower fixed electrode 220, the movable upper electrode 230, the fixing portions 250, and the support members 540. In FIG. 19B, the illustration of them is partially omitted. The support member 540 differs from the support member 240 of the MEMS vibrator 200 in the shape of a beam portion 541. The beam portion 541 has a portion of a different thickness (the Z-axis direction) between the movable upper electrode 230 and the fixing portion 250, where the support member 540 is extended therebetween. More specifically, the beam portion 541 has a recess 541a disposed, for example, in a surface facing the wafer substrate 210. The recess 541a includes a horizontal beam 541b serving as a bottom portion thereof and vertical beams 541c serving as side walls thereof. That is to say, the cross-sectional shape of the beam portion 541 is a “U-shape”.

Since the beam portion 541 has a U-shape at the portion of a different thickness, the beam portion 541 has an easy-to-twist characteristic when, for example, forces in rotational axis directions ω₂₁ and ω₂₂ of the beam portion 541 are applied. For example, compared to the case where the beam portion 541 has a prismatic shape, the beam portion 541 having a U-shape has an easy-to-twist characteristic. Moreover, since the beam portion 541 has a U-shape, the beam portion 541 has a hard-to-flex (bend) characteristic when, for example, forces in shear directions α₂₁ and α₂₂ and shear directions β₂₁ and β₂₂ of the beam portion 541 are applied. That is to say, the horizontal beam 541b can suppress the flex of the beam portion 541 in the β₂₁ and β₂₂ directions, while the vertical beams 541c can suppress the flex of the beam portion 541 in the α₂₁ and α₂₂ directions. Accordingly, the sticking of the movable upper electrode 230 can be suppressed. The other points are similar to those of the MEMS vibrator 200, and therefore, the description is omitted.

The entire disclosure of Japanese Patent Application No. 2012-226670, filed Oct. 12, 2012 and No. 2012-252006, filed Nov. 16, 2012 are expressly incorporated by reference herein.

What is claimed is:

1. A vibrator comprising:
a substrate;
a first electrode disposed above a principal surface of the substrate;
a support member fixed to the substrate; and
a second electrode joined to the support member, being spaced apart from the first electrode, and having a region overlapping the first electrode in plan view of the substrate, wherein
the support member has a reinforcing region where the thickness of the support member in a thickness direction of the substrate is larger than the thickness of the second electrode in the thickness direction of the substrate.

2. The vibrator according to claim 1, wherein
the second electrode is a vibrating plate that flexurally vibrates in the thickness direction of the substrate, and
a node portion of the flexural vibration of the second electrode is joined to the other end of the support member.

3. The vibrator according to claim 1, comprising a plurality of pairs of the support members each pair of which interpose the second electrode therebetween.

4. The vibrator according to claim 1, wherein
the reinforcing region is a region where the thickness of the support member in the thickness direction of the substrate is larger in a direction away from the principal surface of the substrate than the thickness of the second electrode in the thickness direction of the substrate.

5. The vibrator according to claim 1, wherein
the thickness of the reinforcing region in the thickness direction of the substrate increases with distance from the other end of the support member.

6. A manufacturing method of a vibrator including a substrate, a first electrode disposed above a principal surface of the substrate, a support member fixed to the substrate, and a second electrode joined to the support member, being spaced apart from the first electrode, and having a region overlapping the first electrode in plan view of the substrate, wherein the support member has a reinforcing region where the thickness of the support member in a thickness direction of the substrate is larger than the thickness of the second electrode in the thickness direction of the substrate, the method comprising:
stacking a first conductive layer forming the support member, or the support member and the second electrode;
removing at least a portion of the first conductive layer while leaving a region for forming the support member; and
stacking a second conductive layer forming the support member and the second electrode.

7. A manufacturing method of a vibrator including a substrate, a first electrode disposed above a principal surface of the substrate, a support member fixed to the substrate, and a second electrode joined to the support member, being spaced apart from the first electrode, and having a region overlapping the first electrode in plan view of the substrate, wherein the support member has a reinforcing region where the thickness of the support member in a thickness direction of the substrate is larger than the thickness of the second electrode in the thickness direction of the substrate, the method comprising:
stacking a conductive layer forming the support member and the second electrode; and
removing a portion of the conductive layer while leaving a region for forming the support member.

8. A vibrator comprising:
a vibrating portion; and
a support member extended from the vibrating portion, wherein
the support member has a portion of a different thickness in a cross-section as viewed from a direction in which the support member is extended.

9. The vibrator according to claim 8, wherein
a plurality of the support members are extended from the vibrating portion.

10. The vibrator according to claim 8, wherein
the support member is extended from a portion serving as a node of vibration of the vibrating portion.

11. The vibrator according to claim 8, wherein
a fixing portion that fixes the support member above a substrate is disposed.

12. A manufacturing method of a vibrator including a vibrating portion and a support member extended from the vibrating portion, wherein the support member has a portion of a different thickness in a cross-section as viewed from a direction in which the support member is extended, the method comprising:
forming the vibrating portion and the support member;
forming a fixing portion and a lower electrode;
forming an intermediate layer on the support member at the portion of a different thickness; and
removing the intermediate layer after forming the support member.

13. An electronic apparatus comprising the vibrator according to claim 1.

14. An electronic apparatus comprising the vibrator according to claim 2.

15. An electronic apparatus comprising the vibrator according to claim 3.

16. An electronic apparatus comprising the vibrator according to claim 4.

17. A mobile unit comprising the vibrator according to claim 1.

18. A mobile unit comprising the vibrator according to claim 2.

19. A mobile unit comprising the vibrator according to claim 3.

20. A mobile unit comprising the vibrator according to claim 4.
